(19) United States
(12) Patent Application Publication
(10) Pub. No.: US 2013/0300136 A1
(43) Pub. Date: Nov. 14, 2013

(54) DOOR HANDLE ASSEMBLIES REDUCING WOBBLE

(71) Applicant: SCHLAGE LOCK COMPANY LLC, Indianapolis, IN (US)

(72) Inventors: C. Suresha, KGF Karnataka (IN); M. Vijayakumar, Bangalore Karnataka (IN); Brian H. Hood, Zionsville, IN (US); Nathanael S. Murphy, Colorado Springs, CO (US); Jason C. Clifford, Colorado Springs, CO (US)

(73) Assignee: Schlage Look Company LLC, Indianapolis, IN (US)

(21) Appl. No.: 13/889,516

(22) Filed: May 8, 2013

Related U.S. Application Data
(60) Provisional application No. 61/644,382, filed on May 8, 2012.

(51) Int. Cl. E05B 1/00

(52) U.S. Cl. CPC E05B 1/003
USPC 292/336.3

(57) ABSTRACT

A door handle assembly includes a door operator having an operator portion and a shank extending from the operator portion. The door handle assembly also includes a housing with a base portion for mounting to the door and a bearing portion extending from the base portion. The housing houses a portion of a spindle that extends outwardly from the bearing portion to accept the shank of the door operator. The connections of the door operator with the spindle and the spindle to the housing are configured to reduce wobble in the door handle assembly.

### CROSS-REFERENCE TO RELATED APPLICATION

The present application claims priority to U.S. Provisional Application No. 61/644,382 filed on May 8, 2012.

### FIELD OF THE INVENTION

The invention relates to door handle assemblies that reduce wobble of one or more components of the door handle assembly.

### BACKGROUND

Existing door opening mechanisms include various components that are assembled and mounted to the door. The ability to assemble and disassemble the components is important for serviceability and installation requirements. The designs and manufacturing tolerances of these components introduce a certain amount of play or “wobble” in the mechanism. This wobble can result in premature component failure or excessive component wear due to stresses being introduced as a result of the wobble movement. In addition, wobble gives the handle a sloppy or loose feel, which may be undesirable to some users and owners. Therefore, further improvements in this area of technology are desired.

### SUMMARY

There is disclosed herein systems, methods and devices for door handle assemblies that reduce or eliminate wobble in the door handle assemblies. In certain forms, a door handle assembly includes a door operator having an operator portion and a shank extending from the operator portion. The door handle assembly also includes a housing with a base portion that is mountable to the door and a bearing portion extending away from the base portion. The door handle assembly further includes a spindle rotatably coupled to and extending from the base portion so that the shank of the door operator can be mounted to the spindle.

In some embodiments, an elastic spacer is provided between the end of the shank of the door operator and the bearing portion of the housing to occupy the space between the shank and the bearing portion of the base. The spacer can be configured to maintain a separation distance or apply a separation force between the shank and the bearing portion to reduce or eliminate wobble.

In other embodiments, a retaining ring is mounted to the end of the spindle in the base portion of the housing. The retaining ring is configured to bias the outer end of the spindle axially toward the base portion so that the end of the shank of the door operator is biased toward the bearing portion of the housing.

In yet other embodiments, the spindle includes an outer end over which the shank of the door operator is positioned when the door operator is assembled to the shank. The outer end portion of the spindle is flared outwardly during manufacture so that when the shank is pressed onto the spindle, an interference fit is created between the spindle and the shank of the door operator.

In still other embodiments, the spindle includes a slot that opens at its outer end that receives a rib extending from the shank of the door operator. The slot is configured so that it provides an interference fit with the rib when the rib is advanced into the slot to secure the door operator to the spindle.

In other forms, methods for assembling the door handle assembly discussed above are disclosed. Furthermore, each of the embodiments disclosed herein may be employed in a door handle assembly in combination with one or more of the other embodiments disclosed herein. Each of the embodiments and/or combinations of embodiments provides a door handle assembly that reduces play or wobble between two or more components of the door handle assembly. These and other forms, features, embodiments, aspects, advantages, and objects are discussed further below.

### BRIEF DESCRIPTION OF THE DRAWINGS

FIG. 1 is a perspective view of a door handle assembly for mounting to a door.

FIG. 2 is a partial, axial section view of the door handle assembly of FIG. 1.

FIG. 3 is an axial section view of another embodiment of the housing and spindle of the door handle assembly.

FIG. 4 is an elevation view of a portion of FIG. 3 showing the connection of the spindle to the housing with a biased retaining member.

FIG. 5 is a plan view of the biased retaining member.

FIG. 6 is an elevation view of the retaining member.

FIG. 7 is a partial section view showing an interference fit of the spindle with the shank of the door operator.

FIG. 8 is a partial section view showing a tool for forming a flared outer end portion of the spindle to create an interference fit with the shank of the door operator.

FIG. 9 is an elevation of an outer end portion of another embodiment spindle configured to create an interference fit with the rib of the door operator.

FIG. 10 is a partial section view showing the door operator mounted on the spindle of FIG. 9.

FIG. 11 is a section view along line 11-11 of FIG. 10.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

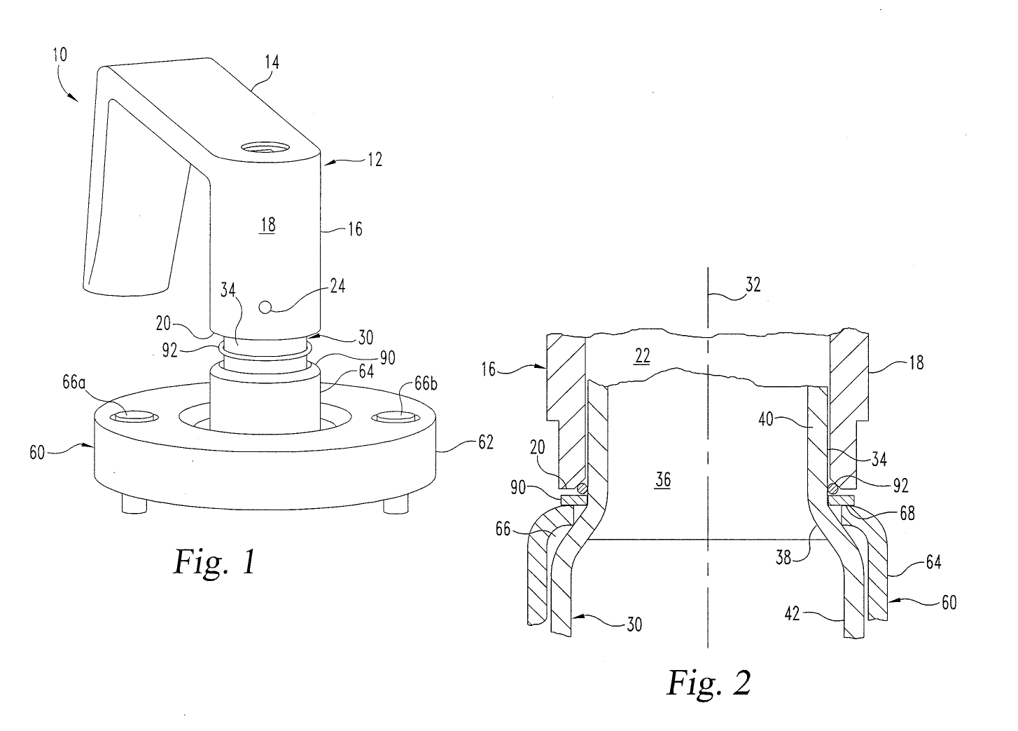

Referring now to the drawings, and more particularly to FIG. 1, there is shown a door handle assembly 10. Door handle assembly 10 is configured to minimize wobble or play between a door operator 12, a spindle 30, and/or a housing 60. Door handle assembly 10 may be part of a door opening and locking system (not shown) which includes a second door handle assembly, a latch mechanism, and a locking mechanism that form a complete system for opening, closing and locking a door (not shown.) When used in a door opening and locking system, the other door handle assembly on the opposite side of the door may be configured identically or similarly to door handle assembly 10 to reduce wobble in both door handle assemblies. As used herein, wobble is any free motion between two or more components of the door handle assembly 12, including motion in one or more of the axial direction defining of axis of rotation of the door handle and in directions non-parallel to the axis of rotation.

Door handle assembly 10 includes door operator 12 which includes an operator portion 14 and a shank 16 extending from operator portion 14. Operator portion 14 is shown in the form of a lever, but could also be a knob or other suitable structure for an operator to grasp and apply torque to operate the latch mechanism and open the door to which door handle assembly 10 is attached. Shank 16 includes an elongated body 18 that extends to a terminal end 20. Shank 16 includes a cylindrical wall 18 that defines a hollow interior 22 (FIG. 2) that receives spindle 30 and houses a portion of a locking mechanism if provided. Shank 16 also includes a bore 24 to receive a set screw or other device to axially secure door operator 12 to spindle 30.

Door handle assembly 10 also includes housing 60 which is mounted to the door and spindle 30 rotatably coupled to housing 60. Spindle 30 is fixed to door operator 12 to rotate about longitudinal axis 32 by operator manipulation of operator portion 14. Base 60 includes a mounting portion 62 including openings for receiving fasteners 66a and 66b that are mounted to the door or door handle assembly on the other side of the door. Referring further to FIG. 2, housing 60 also includes an outwardly extending bearing portion 64 that defines a through-passage 66 for receiving spindle 30.

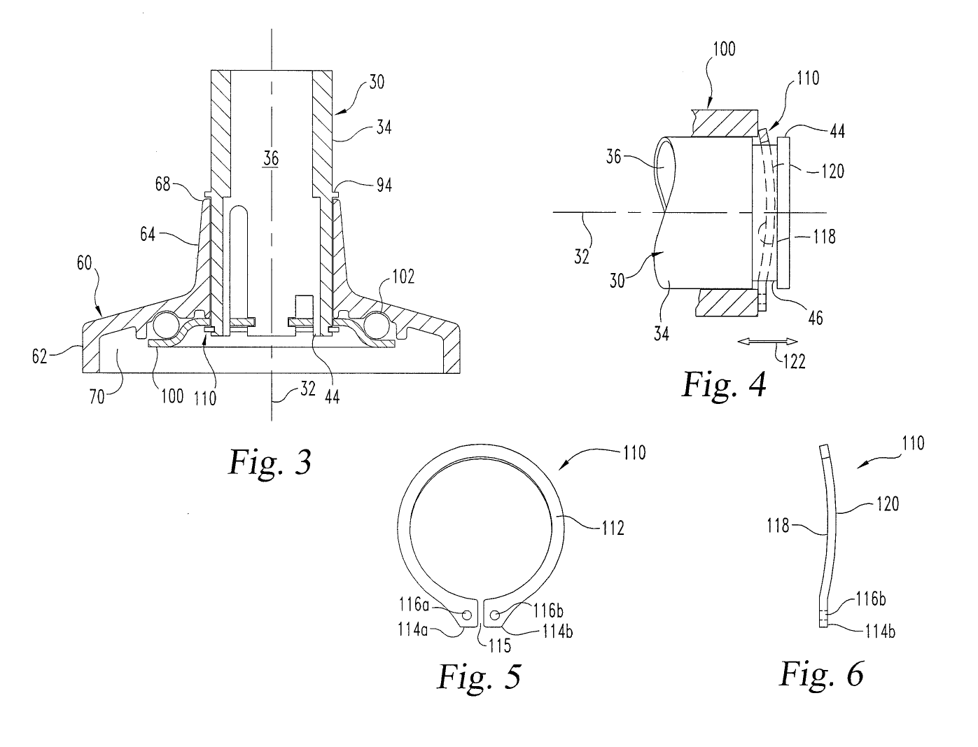

Spindle 30 includes an elongated body 34 extending along longitudinal axis 32. Spindle 30 defines a passage 36 for receipt of, for example, a portion of a locking mechanism (not shown.) In the illustrated embodiment, spindle 30 includes a transition region 38 that transitions body 34 from a first diameter portion 40 to a second diameter portion 42 that is larger in diameter. Embodiments in which spindle 30 is a constant diameter are also contemplated, such as shown in FIG. 3. A retaining ring 90 extends around spindle 30 and abuts an outer end 68 of bearing portion 64 of housing 60.

Door handle assembly 10 includes a compressible, elastic spacer 92 around spindle 30 that occupies the space between terminal end 20 of shank 16 and retaining ring 90. Spacer 92 may be a separate component, or molded or formed integrally with one of spindle 30 and shank 16. In another embodiment, retaining ring 90 is not provided and spacer 92 contacts outer end 68 of base 60. Spacer 92 fills the gap and provides pressure between housing 60 and terminal end 20 of shank 16, biasing spindle 30 against a spring plate 100 (FIG. 3) to which the inner end of spindle 30 is mounted, as discussed further below, to reduce wobble in door handle assembly 10. Spacer 92 prevents dynamic impact between the door operator 12 and housing 60, reducing wear and improving operation and operating life of door handle assembly 12 while permitting relative motion between spindle 30 and base 60. In one embodiment, spacer 92 is an O-ring. In the illustrated embodiment, spacer 92 includes a circular cross-section. In other embodiments, spacer 92 includes other cross-sectional shapes, such as triangular, octagonal, rectangular, square, and elliptical cross-sectional shapes, for example. Spacer 92 may include a smooth outer surface, or include ridges to provide localized areas of interference with the shank 16 and valleys to provide locations for the compressible material to move. Alternately, spacer 92 could include spherical shapes or other suitable geometries on its outer surface to provide localized interference with flexibility and elasticity. Spacer 92 could also be in the form of a compression spring or wave-form spring. In embodiments in which spacer 92 is an O-ring, spacer 92 can be made from silicone. Other embodiments contemplate other materials, such as polymers, foam materials, plastics, and elastomers.

Referring now to FIG. 3, elongated body 34 of spindle 30 extends to an inner end 44 located in a cavity 70 defined by base portion 62 of housing 60. Cavity 70 also houses a spring plate 100 that is connected to base portion 62 and captures a return spring 102. Return spring 102 is coupled to spindle 30 to provide a return force upon release of an actuation force of door operator 12 that operates the latch mechanism to open the door.

As shown further in FIG. 4, inner end 44 of spindle 30 defines a notch or groove 46 extending therearound the receives a retaining member 110. Retaining member 110 is configured to apply a biasing force that biases spindle 30 axially along axis 32 to force an abutment member 94 around body 34 of spindle 30 against outer end 68 of bearing portion 64. In one embodiment, abutment member 94 is a lip integrally formed with body 34. In other embodiments, abutment member 94 can be formed by retaining ring 92 fixed to the outer surface of body 34.

In the illustrated embodiment, as further shown in FIGS. 5 and 6, retaining member 110 is a bowed retaining member that is configured to contact and apply a biasing force between spring plate 100 and body 34 of spindle 30 in groove 46. Retaining member 110 includes a body 112 that defines a ring shape extending between adjacent ends 114a, 114b separated by a gap 115. Each of the ends 114a, 114b includes a hole 116a, 116b, respectively, that can be grasped by a tool separate ends 114a, 114b to apply retaining member 110 around body 34 in groove 46. Body 112 also defines a first side 118 and an opposite second side 120. First side 118 is concavely curved and second side 120 is convexly curved so that the bowed arrangement applies a biasing force between spring plate 100 and spindle 34, forcing the two components away from one another. The biasing force resiliently biases abutment member 94 against outer end 68 of bearing portion 64 as indicated by arrows 122, reducing the wobble in the door handle assembly 10 while still permitting relatively free motion of spindle 30 relative to housing 60.

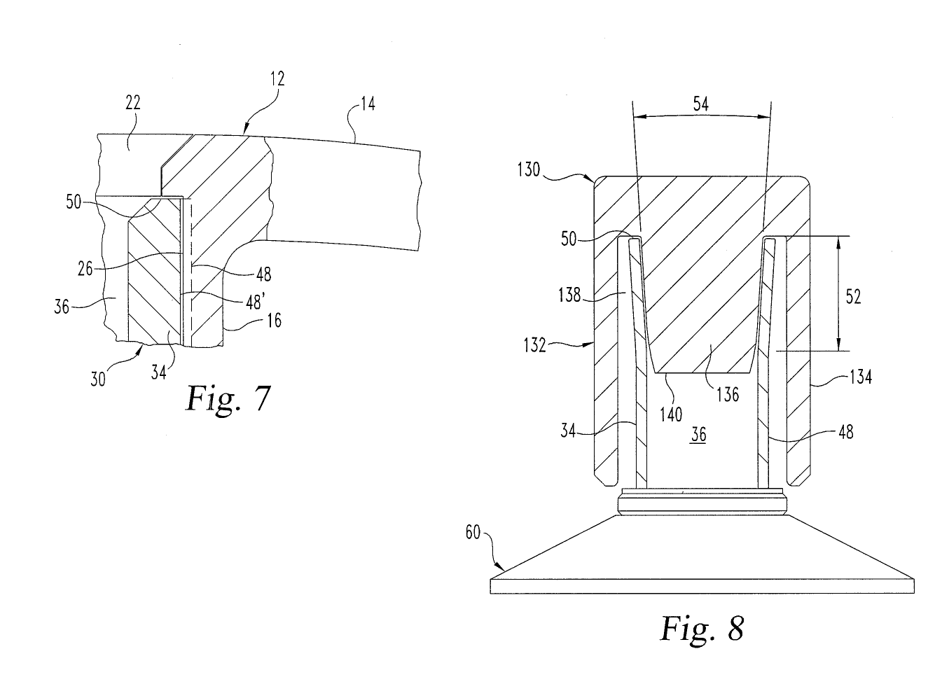

Referring to FIG. 7, there is shown spindle 30 at a second, outer end 50 of elongated body 34. Body 34 defines an outer surface 48 extending around body 34. Shank 16 of door operator 12 includes an inner surface 26 extending along and defining a portion of hollow interior 22. Outer surface 48 is configured to provide an interference fit with inner surface 26 when shank 16 is press fit on spindle 16. As indicated in dashed lines in FIG. 7, outer surface 48 defines an outer diameter before receipt of shank 16 that is inwardly compressed as indicated by outer surface 48′ to receive shank 16 in an interference fit and axially and laterally fix door operator 12 to spindle 30.

Referring to FIG. 8, there is shown one embodiment of a tool and method for forming spindle 30 to create the interference fit with shank 16. In FIG. 8, tool 130 includes a body 132 defining outer cylinder portion 134 and an inner forming member 136. Outer cylinder portion 134 is spaced from forming member 136 with a gap 138 that is larger than the thickness of the wall of body 34 of spindle 30. Forming member 136 includes a tapered profile extending from its inner end 140 so that body 34 of spindle 30 is flared outwardly from second end 50 for a length 52 along body 34 when forming member 136 is pressed into passage 36 of spindle 30. The outwardly flared length of body 34 is formed to extend from second end 50 and defines an outer taper angle 54. Thus, when shank 16 is press fit over second end 50, inner surface 26 contacts and inwardly compresses outer surface 48 of body 34. As discussed further below, spindle 30 can include stress relief and/or living hinge features that facilitate the outward flaring of body 34 during manufacture of spindle 40 and the inward compression of body 34 as shank 16 is press fit on spindle 30.

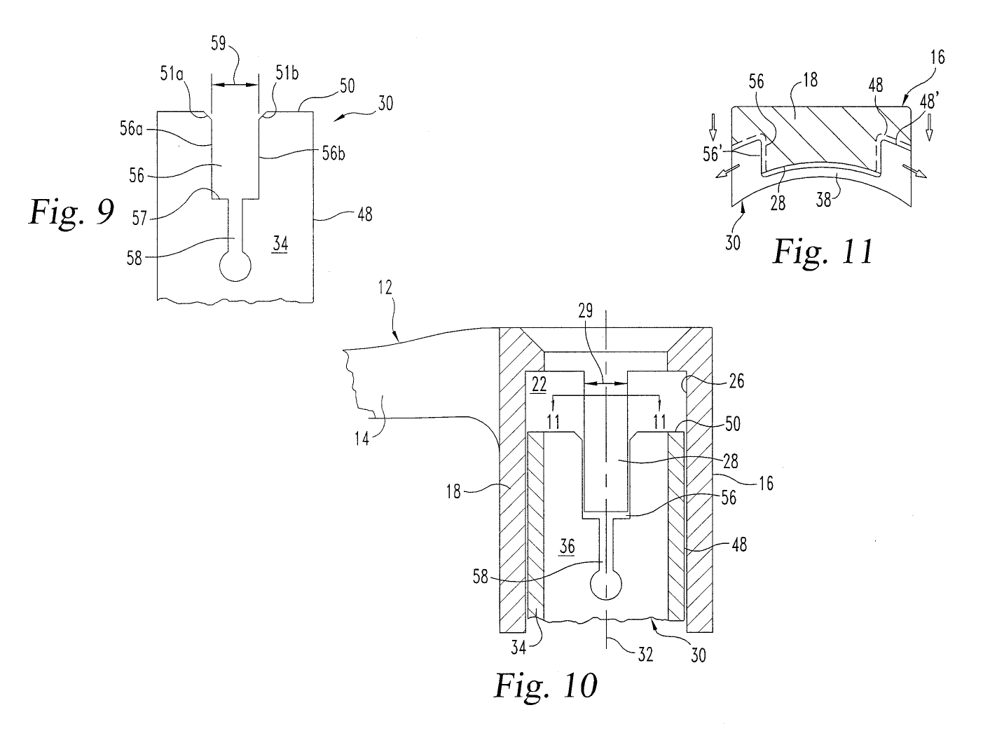

Referring to FIGS. 9-11, a portion of spindle 30 extending from second end 50 is shown in an elevation view. Body 34 defines an elongated slot 56 that opens at second end 50. Slot 56 is defines a width 59 that it is the same as or slightly less than the width 29 of a rib 28 of shank 16. Configurations other than reduced constant width dimension are also contemplated, such as a tapered or stepped configuration along sides 56a, 56b of slot 56. Body 34 also defines a living hinge 58 extending from slot 56 that facilitates flexing of body 34. Hinge 58 can be in the form of a narrower slotted portion extending from a terminal end 57 of slot 56 to a circular relief that allows body 34 to flex at second end 50 to receive shank 12 and rib 28.

Referring to FIGS. 10 and 11, shank 16 includes rib 28 extending from inner wall surface 26 of wall 18 into hollow interior 22. Rib 28 is received in slot 56 and is sized with a width 29 that is the same or slightly larger than the minimum width 59 of slot 56. When rib 28 is received in slot 56 it contacts the sides 56a, 56b of slot 56 to provide an interference fit, as indicated by slot 56′ in contact with rib 28 in FIG. 11. The opening into slot 56 can include beveled edges 51a, 51b at second end 50 to facilitate receipt of rib 28. In addition, when shank 16 is initially press fit on second end 50 of spindle 30 having the outwardly flared configuration discussed above, body 34 deforms inwardly as indicated by outer walls 48′. The press fit of shank 16 with outer wall 48 and of rib 28 with slot 56 provides a secure and stable connection of door operator 12 with spindle 30 that eliminates or reduced wobble.

According to one aspect, a door handle assembly includes a housing with a mounting portion for mounting to a door and a bearing portion facing away from the mounting portion. The door handle assembly also includes a spindle with an elongated body extending along a longitudinal axis through the housing between a first end rotatably secured in the mounting portion and an opposite second end. The spindle further defines a passage that extends between and opens at the first and second ends, and the elongated body includes an outwardly flared portion extending from the second end toward the first end. The door handle assembly also includes a door operator with an operator portion and a shank extending from the operator portion. The shank is positioned over the outwardly flared portion of the spindle and inwardly compresses the outwardly flared portion to create an interference fit between the shank and the spindle.

In one embodiment, the spindle includes a slot opening at and extending from the second end toward the first end of the spindle. The shank of the door operator includes a rib extending into a hollow interior of the shank that is received in the slot when the shank is positioned over the outwardly flared portion of the spindle. In one refinement, the slot extends from the second end of the body of the spindle to a slot terminal end. The slot defines a width between opposite sides of the slot that is less than a width between opposite sides of the rib to create an interference fit between the rib and the spindle. In a further refinement, the body of the spindle includes a living hinge extending from the terminal end of the slot toward the first end of the spindle. In another refinement, the body of the spindle is beveled at the opening of the slot.

In another embodiment, the shank extends from the operator portion to a first shank end and defines a hollow interior opening at the first shank end. In one refinement, the door handle assembly includes an elastic spacer around the spindle that extends between the first shank end and one of the bearing portion of the housing and a retaining ring in contact with the bearing portion of the housing. In a further refinement, the elastic spacer is a silicone O-ring.

In another embodiment, the door handle assembly includes a retaining member that rotatably secures the first end of the spindle to the housing and axially biases the spindle toward the bearing portion of the housing. In one refinement, the retaining member is a retaining ring that defines a bowed profile in the axial direction so that a first side of the retaining ring contacts the spindle in a groove that receives the retaining member and an opposite second side of the retaining member contacts a member of the housing.

In another embodiment, the spindle includes a slot opening at and extending from the second end toward the first end to a slot terminal end, and the spindle further includes a stress relief slot extending from the slot terminal end toward the first end of the body of the spindle. In yet another embodiment, the shank of the door operator is press fit on the outwardly flared portion of the spindle.

According to another aspect, a door handle assembly includes a housing with a mounting portion for mounting to a door and a bearing portion extending from the mounting portion. The door handle assembly also includes a spindle with an elongated body extending along a longitudinal axis through the housing between a first end rotatably secured in the mounting portion and an opposite second. The spindle further defines a passage extending between and opening at the first and second ends. The elongated body of the spindle includes a slot extending from the second end to a terminal end of the slot. The door handle assembly also includes a door operator with an operator portion and a shank extending from the operator portion. The shank includes an inner wall defining a hollow interior and a rib projecting from the inner wall into the hollow interior. The rib defines a width that is greater than a width of the slot to create an interference fit between the shank and the spindle.

In one embodiment, the spindle includes an outwardly flared portion extending from the second end along a portion of a length of the spindle and the inner wall of the shank contacts and inwardly compresses the outwardly flared portion to create an interference fit between the door operator and the spindle. In one refinement, the body of the spindle includes a living hinge extending from the terminal end of the slot.

In another embodiment, the shank extends from the operator portion to a first shank end and the hollow interior opens at the first shank end. In one refinement, the door handle assembly includes an elastic spacer extending between and contacting the first shank end and one of the bearing portion of the housing and a retaining member between the elastic spacer and the bearing portion of the housing.

In another embodiment, the door handle assembly includes a retaining member that rotatably secures the first end of the spindle to the housing and axially biases the second end of the spindle toward the bearing portion of the housing. In one refinement, the biasing member is a retaining ring that defines a concave side and a convex side, and one of the concave and convex sides contacts a member of the housing and the other of the concave and convex sides contacts the spindle to axially bias the first end of the spindle away from the housing. In yet a further embodiment, the shank of the door operator is press fit on the second end of the spindle.

In another aspect, a door handle assembly includes a housing with a mounting portion for mounting to a door and a bearing portion extending from the mounting portion. The door handle assembly also includes a spindle with an elongated body extending along a longitudinal axis through the housing between a first end rotatably secured in the mounting portion and an opposite second. The spindle further defines a passage extending between and opening at the first and second ends. The door handle assembly includes a door operator with an operator portion and a shank extending from the operator portion to a first shank end. The shank includes an inner wall defining a hollow interior opening at the first shank end that is sized to receive the elongated body of the spindle therein. An elastic spacer is positioned around the spindle that extends between and contacts the first shank end and one of the bearing portion of the housing and a retaining ring in contact with the bearing portion of the housing.

In yet another aspect, a door handle assembly includes a housing with a mounting portion for mounting to a door and a bearing portion extending from the mounting portion. The door handle assembly also includes a spindle with an elongated body extending along a longitudinal axis through the housing between a first end rotatably secured in the mounting portion and an opposite second. The spindle defines a passage extending between and opening at the first and second ends of the spindle. The door handle assembly also includes a door operator with an operator portion and a shank extending from the operator portion to a first shank end. The shank including an inner wall defining a hollow interior opening at the first shank end that is sized to receive the elongated body of the spindle therein. A retaining member is rotatably secured to the first end of the spindle so secure the spindle to the housing in the mounting portion of the housing. The retaining member is configured to axially bias the second end of the spindle toward the bearing portion of the housing.

While the invention has been illustrated and described in detail in the drawings and foregoing description, the same is to be considered as illustrative and not restrictive in character, it being understood that only the certain embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A door handle assembly, comprising:
a housing including a mounting portion for mounting to a door and a bearing portion facing away from the mounting portion;
a spindle including an elongated body extending along a longitudinal axis through the housing between a first end rotatably secured in the mounting portion and an opposite second end, the spindle further defining a passage extending between and opening at the first and second ends, wherein the elongated body includes an outwardly flared portion extending from the second end toward the first end; and
a door operator including an operator portion and a shank extending from the operator portion, the shank being positioned over the outwardly flared portion of the spindle and inwardly compressing the outwardly flared portion to create an interference fit between the shank and the spindle.

2. The door handle assembly of claim 1, wherein the spindle includes a slot opening at and extending from the second end toward the first end of the spindle and the shank of the door operator includes a rib extending into a hollow interior of the shank, the rib being received in the slot when the shank is positioned over the outwardly flared portion of the spindle.

3. The door handle assembly of claim 2, wherein the slot extends from the second end of the body of the spindle to a slot terminal end, wherein the slot defines a width between opposite sides of the slot that is less than a width between opposite sides of the rib to create an interference fit between the rib and the spindle.

4. The door handle assembly of claim 3, wherein the body of the spindle includes a living hinge extending from the terminal end of the slot toward the first end of the spindle.

5. The door handle assembly of claim 4, wherein the body of the spindle is beveled at the opening of the slot.

6. The door handle assembly of claim 1, wherein the shank extends from the operator portion to a first shank end, the shank further defining a hollow interior opening at the first shank end.

7. The door handle assembly of claim 6, further comprising an elastic spacer around the spindle that extends between the first shank end and one of the bearing portion of the housing and a retaining ring in contact with the bearing portion of the housing.

8. The door handle assembly of claim 1, further comprising a retaining member that rotatably secures the first end of the spindle to the housing and axially biases the spindle toward the bearing portion of the housing.

9. The door handle assembly of claim 8, wherein the retaining member is a retaining ring that defines a bowed profile in the axial direction so that a first side of the retaining ring contacts the spindle in a groove that receives the retaining member and an opposite second side of the retaining member contacts a member of the housing.

10. The door handle assembly of claim 1, wherein the spindle includes a slot opening at and extending from the second end toward the first end to a slot terminal end, the spindle further including a stress relief slot extending from the slot terminal end toward the first end of the body of the spindle.

11. The door handle assembly of claim 1, wherein the shank of the door operator is press fit on the outwardly flared portion of the spindle.

12. A door handle assembly, comprising:
a housing including a mounting portion for mounting to a door and a bearing portion extending from the mounting portion;
a spindle including an elongated body extending along a longitudinal axis through the housing between a first end rotatably secured in the mounting portion and an opposite second, the spindle further defining a passage extending between and opening at the first and second ends, wherein the elongated body includes a slot extending from the second end to a terminal end of the slot; and
a door operator including an operator portion and a shank extending from the operator portion, the shank including an inner wall defining a hollow interior and a rib projecting from the inner wall into the hollow interior, wherein the rib defines a width that is greater than a width of the slot to create an interference fit between the shank and the spindle.

13. The door handle assembly of claim 12, wherein the spindle includes an outwardly flared portion extending from the second end along a portion of a length of the spindle, and the inner wall of the shank contacts and inwardly compresses the outwardly flared portion to create an interference fit between the door operator and the spindle.

14. The door handle assembly of claim 13, wherein the body of the spindle includes a living hinge extending from the terminal end of the slot.

15. The door handle assembly of claim 12, wherein the shank extends from the operator portion to a first shank end and the hollow interior opens at the first shank end.

16. The door handle assembly of claim 15, further comprising an elastic spacer extending between and contacting the first shank end and one of the bearing portion of the housing and a retaining member between the elastic spacer and the bearing portion of the housing.

17. The door handle assembly of claim 12, further comprising a retaining member that rotatably secures the first end of the spindle to the housing and axially biases the second end of the spindle toward the bearing portion of the housing.

18. The door handle assembly of claim 17, wherein the biasing member is a retaining ring that defines a concave side and a convex side, wherein one of the concave and convex sides contacts a member of the housing and the other of the concave and convex sides contacts the spindle to axially bias the first end of the spindle away from the housing.

19. The door handle assembly of claim 12, wherein the shank of the door operator is press fit on the second end of the spindle.

20. A door handle assembly, comprising:
a housing including a mounting portion for mounting to a door and a bearing portion extending from the mounting portion;
a spindle including an elongated body extending along a longitudinal axis through the housing between a first end rotatably secured in the mounting portion and an opposite second, the spindle further defining a passage extending between and opening at the first and second ends;
a door operator including an operator portion and a shank extending from the operator portion to a first shank end, the shank including an inner wall defining a hollow interior opening at the first shank end that is sized to receive the elongated body of the spindle therein; and
an elastic spacer around the spindle that extends between and contacts the first shank end and one of the bearing portion of the housing and a retaining ring in contact with the bearing portion of the housing to maintain the second end of the spindle in axial engagement with a member connected to the mounting portion of the housing.

21. The door handle assembly of claim 20, wherein the elastic spacer is a silicone O-ring.

22. The door handle assembly of claim 20, wherein the member is a spring plate that captures a door operator return spring in the mounting portion.

23. A door handle assembly, comprising:
a housing including a mounting portion for mounting to a door and a bearing portion extending from the mounting portion;
a spindle including an elongated body extending along a longitudinal axis through the housing between a first end rotatably secured in the mounting portion and an opposite second, the spindle further defining a passage extending between and opening at the first and second ends;
a door operator including an operator portion and a shank extending from the operator portion to a first shank end, the shank including an inner wall defining a hollow interior opening at the first shank end that is sized to receive the elongated body of the spindle therein; and
a retaining member that rotatably secures the first end of the spindle to the housing in the mounting portion of the housing, wherein the retaining member is configured to axially bias the second end of the spindle toward the bearing portion of the housing.

24. The door handle assembly of claim 23, wherein the retaining member is a retaining ring that defines a bowed profile in the axial direction so that a first side of the retaining ring contacts the spindle in a groove that receives the retaining member and an opposite second side of the retaining member contacts a member of the housing.

25. The door handle assembly of claim 23, wherein the retaining member is a retaining ring that defines a concave side and a convex side, wherein one of the concave and convex sides contacts a member of the housing and the other of the concave and convex sides contacts the spindle to axially bias the second end of the spindle toward the bearing portion of the housing.
